(19) United States
(12) Patent Application Publication
(10) Pub. No.: US 2007/0085911 A1
(43) Pub. Date: Apr. 19, 2007

(54) Apparatus for color correction of subject-image data, and method of controlling same

(75) Inventor: Tomokazu Nakamura, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/580,890

(22) Filed: Oct. 16, 2006

(30) Foreign Application Priority Data
Oct. 17, 2005 (JP) 2005-301134

(51) Int. Cl. H04N 9/73

(52) U.S. Cl. 348/223.1

(57) ABSTRACT

A white balance adjustment that conforms to the color temperature of light at the time of imaging is applied to image data. Specifically, a face-image area is detected from the image of a subject. A skin-tone area is detected from the detected face-image area, and the color temperature of light in the environment in which the image was sensed is detected from the detected skin-tone area. White balance gain conforming to the detected color temperature is calculated. Image data representing the image of the subject is subjected to a white balance adjustment using the white balance gain calculated.

### BACKGROUND OF THE INVENTION

1. Field of the Invention

This invention relates to an apparatus for correcting the color of subject-image data, an apparatus for applying a gamma correction to subject-image data, an apparatus for reducing noise in subject-image data and an apparatus for contour emphasis of subject-image data, and methods of controlling these apparatuses.

2. Description of the Related Art

When the image of a subject is sensed using a digital still camera or the like and the subject is a person, it is generally desired that the portion of the person that is the face appear in attractive fashion. In order to achieve this, it has been proposed to control the shutter or iris of the video still camera based upon a signal representing the subject (see the specification of Japanese Patent Application Laid-Open No. 5-110936) or to-obtain an image after the execution of optimum processing (see the specification of Japanese Patent Application Laid-Open No. 2003-274427).

In order to make a specific part of a target image appear attractively, however, there is still room for improvement.

### SUMMARY OF THE INVENTION

Accordingly, an object of the present invention is to make a specific part of a target image appear attractively.

According to a first aspect of the present invention, the foregoing object is attained by providing an apparatus for correcting color of subject-image data, comprising: a target-image detecting device for detecting a target image from a subject image represented by subject-image data applied thereto; a color correction parameter deciding device for deciding color correction parameters based upon the target image detected by the target-image detecting device; and a color correction circuit for applying a color correction to the subject-image data in accordance with the color correction parameters decided by the color correction parameter deciding device.

The first aspect of the present invention also provides a control method suited to the above-described apparatus for correcting color of subject-image data. Specifically, there is provided a method of controlling an apparatus for correcting color of subject-image data, comprising the steps of: detecting a target image from a subject image represented by applied subject-image data; deciding color correction parameters based upon the target image detected; and applying a color correction to the subject-image data in accordance with the color correction parameters decided.

In accordance with the first aspect of the present invention, a target image is detected from the image of a subject represented by applied subject-image data, and color correction parameters are decided based upon the target image detected. A color correction is applied to the subject-image data in accordance with the color correction parameters decided. The color of the target image can be made a desired color by deciding the color correction parameters in such a manner that the color of the target image becomes the desired color.

The target-image detecting device detects a skin-tone image portion from the image of the subject. Since skin tone differs depending upon race, the color of the skin tone would be decided by the target race.

By way of example, the color correction parameter deciding device includes a light-source/color-temperature detecting device for detecting, based upon the target image detected by the target-image detecting device, at least one of the kind of light source under which the subject image was obtained and color temperature in the environment in which the image of the subject was sensed. The color correction parameter deciding device decides the color correction parameters based upon at least one of the light source and color temperature detected by the light-source/color-temperature detecting device.

According to a second aspect of the present invention, the foregoing object is attained by providing an apparatus for applying a gamma correction to subject-image data, comprising: a target-image detecting device for detecting a target image from a subject image represented by subject-image data applied thereto; a gamma correction coefficient deciding device for deciding gamma correction coefficients based upon the target image detected by the target-image detecting device; and a gamma correction circuit for applying a gamma correction to the subject-image data in accordance with the gamma correction coefficients decided by the gamma correction coefficient deciding device.

The second aspect of the present invention also provides a control method suited to the above-described apparatus for applying a gamma correction to subject-image data. Specifically, there is provided a method of controlling an apparatus for applying a gamma correction to subject-image data, comprising the steps of: detecting a target image from a subject image represented by applied subject-image data; deciding gamma correction coefficients based upon the target image detected; and applying a gamma correction to the subject-image data in accordance with the gamma correction coefficients decided.

In accordance with the second aspect of the present invention, a target image is detected from the image of a subject, and gamma correction coefficients are decided based upon the target image detected. A gamma correction is applied to the subject-image data in accordance with the gamma correction coefficients decided. A gamma correction can be performed in such a manner that the target image attains the appropriate brightness.

According to a third aspect of the present invention, the foregoing object is attained by providing an apparatus for reducing noise in subject-image data, comprising: a target-image detecting device for detecting a target image-from a subject-image represented by subject-image data applied thereto; a noise reduction parameter deciding device for deciding noise reduction parameters based upon the target image detected by the target-image detecting device; and a noise reduction circuit for applying noise reduction processing to the subject-image data in accordance with the noise reduction parameters decided by the noise reduction parameter deciding device.

The third aspect of the present invention also provides a control method suited to the above-described apparatus for reducing noise in subject-image data. Specifically, there is provided a method of controlling an apparatus for reducing noise in subject-image data, comprising the steps of: detecting a target image from a subject image represented by applied subject-image data; deciding noise reduction parameters based upon the target image detected; and applying noise reduction processing to the subject-image data in accordance with the noise reduction parameters decided.

In accordance with the third aspect of the present invention, a target image is detected from the image of a subject, and noise reduction parameters are decided based upon the target image detected. Noise reduction processing is applied to the subject-image data in accordance with the noise reduction parameters decided. Noise reduction processing suited to the target dynamic range can thus be executed.

In a case where the applied subject-image data is color image data in which a plurality of color elements are output in order (red, green and yellow components are the color components if the subject-image data is obtained based upon an RGB filter, and cyan, magenta and yellow are the color components if the subject-image data is obtained based upon a CMY filter), the apparatus further comprises a synchronizing circuit for executing synchronizing processing to interpolate the color image data by the color elements, thereby obtaining color image data one per-color-element basis. In this case, the noise reduction circuit would apply noise reduction processing to color image data that has been output from the synchronizing circuit.

The subject-image data that is input to the noise reduction circuit is, e.g., CCD-RAW data. Since the noise reduction processing is applied to CCD-RAW image data, noise can be prevented from being increased by processing of subsequent stages.

The apparatus may further comprise a contour emphasizing circuit for deciding a contour emphasizing parameter in accordance with the noise reduction parameters decided by the noise reduction parameter deciding device, and subjecting subject-image data, which has undergone noise reduction processing in the noise reduction circuit, to contour emphasizing processing using the contour emphasizing parameters decided. Thus, a contour blurred by noise reduction can be emphasized.

The apparatus may further comprise a noise-amount detecting device for detecting amount of noise in a target image detected by the target-image detecting device. In this case, the noise reduction parameter deciding device would decide the noise reduction parameters based upon the amount of noise detected by the noise-amount detecting device.

According to a fourth aspect of the present invention, the foregoing object is attained by providing an apparatus for contour emphasis of subject-image data, comprising: a target-image detecting device for detecting a target image from a subject image represented by subject-image data applied thereto; a contour emphasizing parameter deciding device for deciding first contour emphasizing parameters of the target image detected by the target-image detecting device and second contour emphasizing parameters of an image portion of the subject image from which the target image is excluded; and a contour emphasizing circuit for applying contour emphasizing processing to image data representing the target image in the subject-image data using the first contour emphasizing parameters, and applying contour emphasizing processing to image data representing the image portion from which the target image is excluded using the second contour emphasizing parameters.

The fourth aspect of the present invention also provides a control method suited to the above-described apparatus for contour emphasis of subject-image data. Specifically, there is provided a method of controlling an apparatus for contour emphasis of subject-image data, comprising the steps of: detecting a target image from a subject image represented by applied subject-image data; deciding first contour emphasizing parameters of the detected target image and second contour emphasizing parameters of an image portion of the subject image from which the target image is excluded; and applying contour emphasizing processing to image data representing the target image in the subject-image data using the first contour emphasizing parameters, and applying contour emphasizing processing to image data representing the image portion from which the target image is excluded using the second contour emphasizing parameters.

In accordance with the fourth aspect of the present invention, a target image is detected from the image of a subject. First contour emphasizing parameters of the detected target image and second contour emphasizing parameters of an image portion of the subject image from which the target image is excluded are decided. Contour emphasizing processing is applied to image data representing the target image using the first contour emphasizing parameters, and contour emphasizing processing is applied to image data representing the image portion from which the target image is excluded using the second contour emphasizing parameters. Contour emphasis can be performed using contour emphasizing parameters for the target image portion and different contour emphasizing parameters for image portion from which the target image is excluded.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is part of a block diagram illustrating the electrical structure of a digital still camera according to a first embodiment of the present invention;

FIG. 2 illustrates an example of the image of a subject;

FIG. 3 illustrates an example of a skin-tone area that has been detected;

FIG. 4 illustrates an example of a graph of skin-tone black body locus vs. color temperatures of fluorescent lamps;

FIG. 5 illustrates the relationship between light source/color temperature and white balance gain, etc;

FIG. 6 is a flowchart illustrating processing for deciding white balance gain and the like according to the first embodiment;

FIG. 7 illustrates an a*b* coordinate system according to a second embodiment of the present invention;

FIG. 8 illustrates the relationship between (a) hue angles of skin tone and (b) linear matrix coefficients and color difference coefficients;

FIG. 9 is a flowchart illustrating processing for deciding linear matrix coefficients and the like according to the second embodiment;

FIG. 10 is part of a block diagram illustrating the electrical structure of a digital still camera according to a third embodiment of the present invention;

FIG. 11 illustrates an example of a gamma correction curve;

FIG. 12 is a flowchart illustrating processing for creating a revised gamma correction table according to the third embodiment;

FIG. 13 is part of a block diagram illustrating the electrical structure of a digital still camera according to a fourth embodiment of the present invention;

FIG. 14A illustrates the relationship between S/N ratios of face images and filter sizes, and FIG. 14B illustrates the relationship between S/N ratios of face images and filter coefficients;

FIG. 15 is a flowchart illustrating processing for calculating revised noise reduction parameters according to the fourth embodiment;

FIGS. 16 and 17 are parts of block diagrams illustrating the electrical structures of digital still cameras according to a modification and a fifth embodiment, respectively;

FIG. 18 illustrates an example of contour gains of a face-image portion and background portion;

FIG. 19 is a flowchart illustrating processing for deciding contour emphasizing parameters according to the fifth embodiment;

FIG. 20 is part of a block diagram illustrating the electrical structure of a digital still camera according to a sixth embodiment of the present invention;

FIG. 21 illustrates the relationship between S/N ratio of a face image and contour gain; and

FIG. 22 is a flowchart illustrating processing for calculating revised noise reduction parameters and revised contour emphasizing parameters according to the sixth embodiment.

### DESCRIPTION OF THE PREFERRED EMBODIMENTS

Preferred embodiments of the present invention will now be described in detail with reference to the drawings.

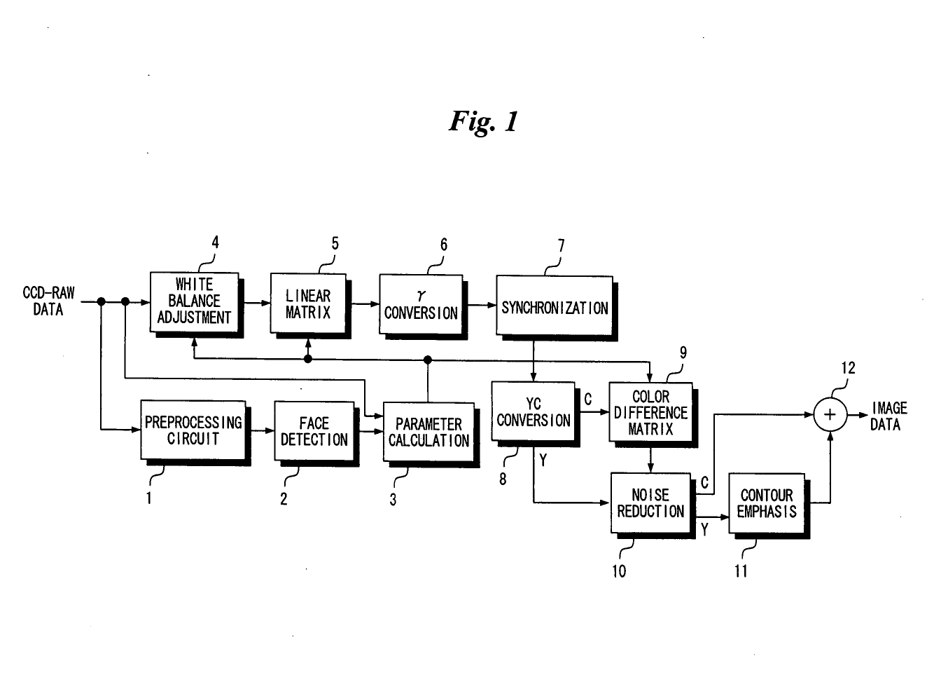

FIG. 1 is a block diagram illustrating the electrical structure of a digital still camera according to a first embodiment of the present invention.

In the digital still camera according to this embodiment, the image of a face is detected from within the image of a subject, and a skin-tone image area is detected from the portion of the image that is the face. On the basis of the image within the skin-tone image area detected, either the light source used to sense the image of the subject or the color temperature in the environment in which the image of the subject was sensed is inferred. As will be described later, white balance gain of a white balance adjustment circuit, linear matrix coefficients in a linear matrix circuit and color difference matrix coefficients in a color different matrix circuit are decided optimally based upon the inferred light source or color temperature. As a result, an appropriate white balance adjustment that conforms to the light source, etc., at the time of imaging can be performed, and matrix processing is executed in such a manner that the skin tone will become the objective attractive color.

Color CCD-RAW data representing the image of the subject is input to a preprocessing circuit 1 and white balance adjustment circuit 4.

The preprocessing circuit 1 extracts only image data of the green color component from the color CCD-RAW data. The preprocessing circuit 1 downsamples the extracted image data of the green color component and applies processing to raise the gain thereof. The image data that has been output from the preprocessing circuit 1 is input to a face detection circuit 2. The latter detects a face-image area from within the image of the subject.

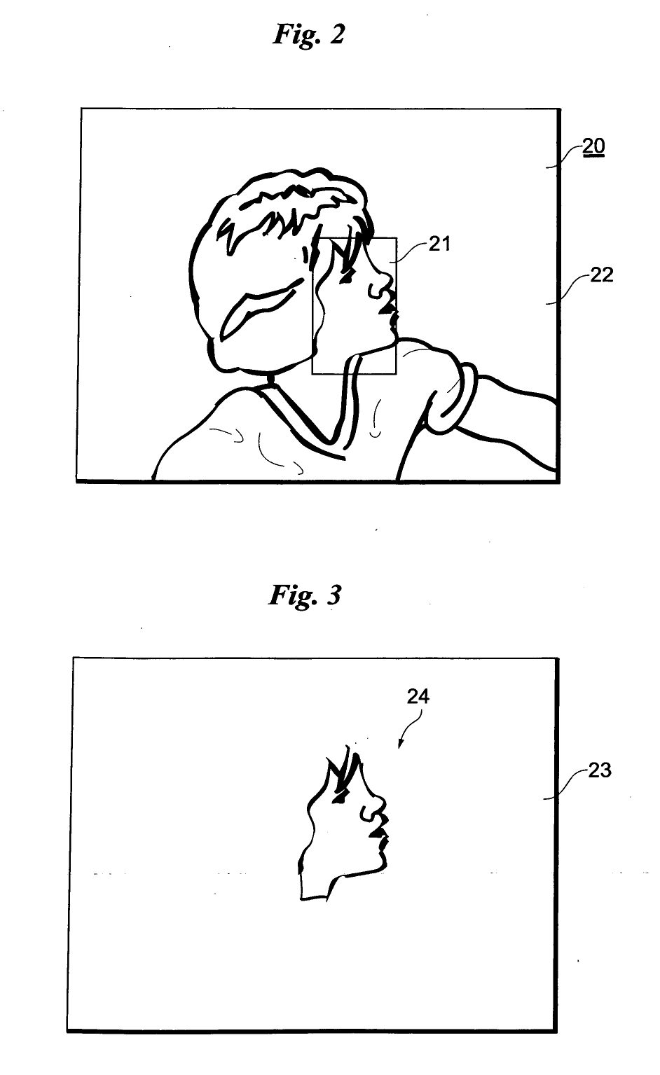

FIG. 2 illustrates an example of the image 20 of a subject.

A face-image area 21 is detected by applying face detection processing to the subject image 20. If a plurality of face images exist, then a plurality of face images are detected. If there are a plurality of face images, then one face-image area is decided upon, e.g., the face-image area of largest size, the area that is most face-like, or the face-image area that is brightest. The area other than face-image area 21 decided upon shall be referred to as a “background area”.

With reference again to FIG. 1, the image data representing the image of the subject and data representing the face-image area is input to a parameter calculation circuit 3. The latter detects a skin-tone area having a skin-tone image portion from within the face-image area.

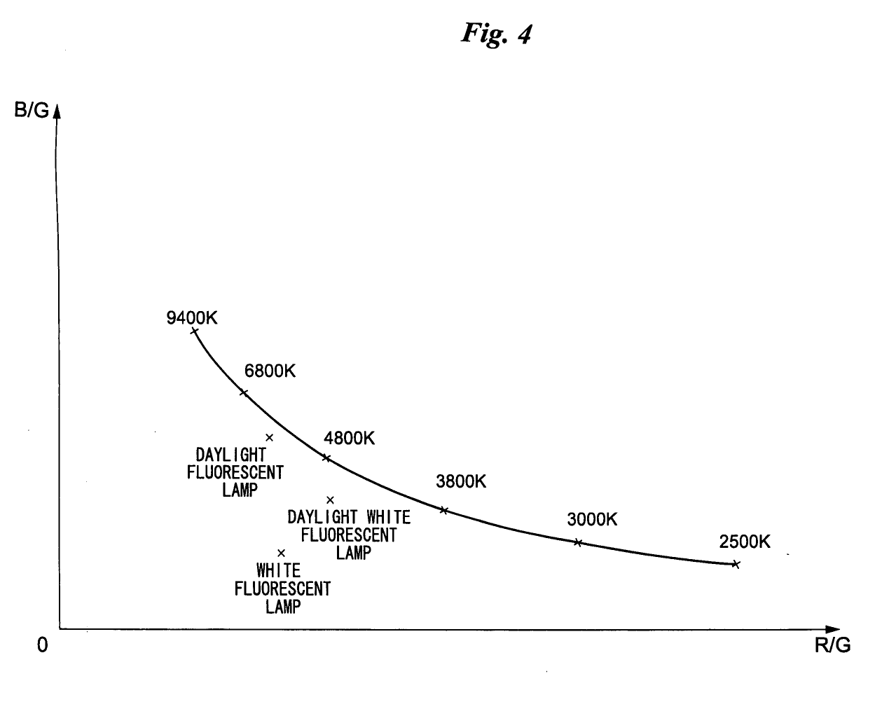

FIG. 3 illustrates an example of a skin-tone area.

A skin-tone area 24 having a skin-tone component is detected from within the face-image area 21. A subject image 23 in which the skin-tone area 24 is defined is obtained.

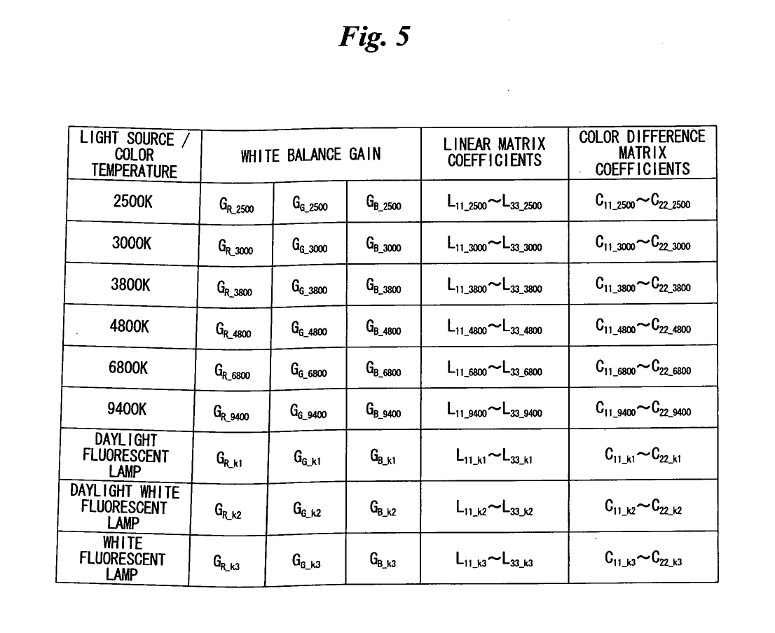

FIG. 4 illustrates an example of skin-tone positions and skin-tone black-body locus.

Skin-tone positions under a daylight-color fluorescent lamp, daylight white-color fluorescent lamp and white-color fluorescent lamp, and a skin-tone color temperature locus (black-body locus) are obtained in advance in R/G-B/G color space, as illustrated in FIG. 4. The skin-tone positions and data indicating the skin-tone black-body locus have been stored in the parameter calculation circuit 3.

The detected skin-tone area is divided into a plurality of areas and the image data in each divided area is plotted in R/G-B/G color space. The position of the center of gravity of the plurality of plotted positions is calculated. If the calculated position of the center of gravity is near the positions of the daylight-color fluorescent lamp, daylight white-color fluorescent lamp and white-color fluorescent lamp, it is construed that the image of the subject was sensed under the illumination of the fluorescent lamp having the position closest to the center of gravity. Further, if the position of the center of gravity is near the skin-tone black-body locus, then the color temperature is calculated from the closest position on the skin-tone black-body locus. The light source or the color temperature is thus calculated.

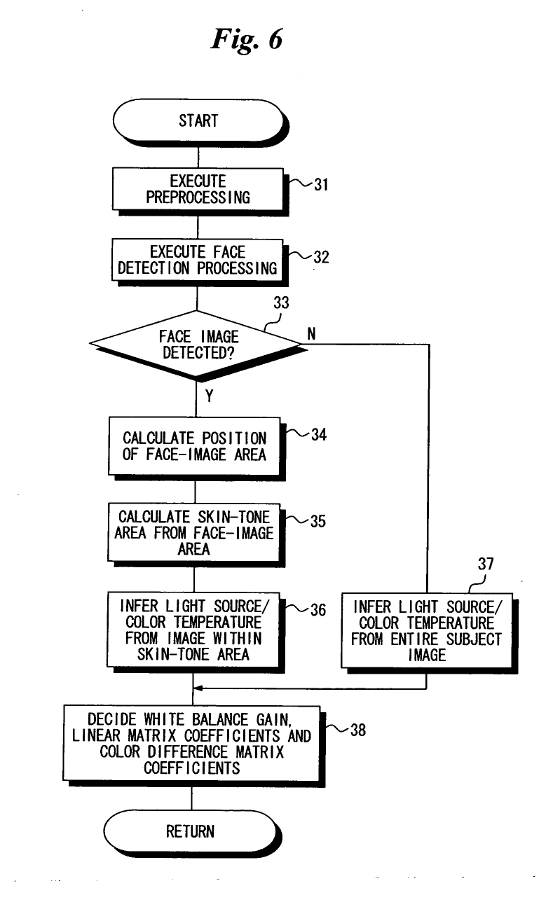

FIG. 5 illustrates an example of a coefficient table indicating the relationship between calculated light source or color temperature and white balance gain, linear matrix coefficients and color difference matrix coefficients.

White balance gain, linear matrix coefficients and color difference coefficients suited to the image of the subject sensed in these light environments are stipulated for every light source or color temperature. This coefficient table also has been stored beforehand in the parameter calculation circuit 3. For example, the white balance gain, linear matrix coefficients and color difference coefficients corresponding to the inferred color temperature or light source are decided upon by being read out.

Since the goal of color reproduction changes depending upon the presumed light source or color temperature, the coefficients, etc., that meet the goal are found in advance. For example, in the case of skin tone, red tint is reduced and saturation lowered when the color temperature is low. When the color temperature is high, on the other hand, yellow tint is increased and saturation raised. Further, since a fluorescent lamp is a special light source, color reproduction of a chromatic color will be unfavorable even if the white balance of gray is adjusted. Linear matrix coefficients and color difference matrix coefficients are stipulated, therefore, so as to improve the color reproduction of a chromatic color.

The color temperatures cited in the FIG. 5 are representative color temperatures, and there are cases where the color temperature of a presumed light source will not agree with a representative color temperature. In such case, color correction coefficients of the presumed color temperature are calculated by interpolation from the color correction coefficients of the neighboring representative color temperatures.

With reference again to FIG. 1, the white balance gain of the white balance adjustment circuit 4, linear matrix coefficients in a linear matrix circuit 5 and color difference matrix coefficients in a color difference matrix circuit 9 are decided based upon the coefficient table in accordance with the calculated light source or color temperature. The white balance gain, linear matrix coefficients and color difference matrix coefficients decided are applied to the white balance adjustment circuit 4, linear matrix circuit 5 and color difference matrix circuit 9, respectively.

White balance adjustment of the CCD-RAW data is performed in the white balance adjustment circuit 4 in accordance with the applied white balance gain, and the adjusted data is output as image data. The image data that has been output from the white balance adjustment circuit 4 is applied to the linear matrix circuit 5, which executes filtering processing stipulated by the applied linear matrix coefficients. By virtue of this filtering processing, an adjustment is applied in such a manner that the hue, brightness and saturation of the image data will become those of an attractive color for which skin tone is the objective.

The image data that has been output from the linear matrix circuit 5 is subjected to a gamma conversion (correction) in a gamma conversion circuit 6 and the corrected data is input to a synchronization processing circuit 7. Image data that has been synchronized in the synchronization processing circuit 7 is applied to a YC conversion circuit 8, which proceeds to generate luminance data Y and color difference data C. The color difference data generated is input to the color difference matrix circuit 9. The latter executes filtering processing stipulated by the color difference matrix coefficients provided by the parameter calculation circuit 3. The color of the color difference data is finely adjusted in the color difference matrix circuit 9. The color difference data C that has been output from the color difference matrix circuit 9 and luminance data Y that has been output from the YC conversion circuit 8 is input to a noise reduction circuit 10.

The noise reduction circuit 10 applies noise reduction processing to the input luminance data Y and color difference data C. The luminance data that has undergone noise reduction processing is applied to a contour emphasizing circuit 11, and the color difference data C is applied to an adder circuit 12. The contour emphasizing circuit 11 emphasizes the contour of the subject image blurred by noise reduction processing. The luminance data that has been output from the contour emphasizing circuit 11 is applied to the adder circuit 12. The latter adds the luminance data Y and color difference data C, whereby there is obtained image data representing a subject image having vibrant color that takes into consideration the lighting environment that prevailed when the image of the subject was sensed.

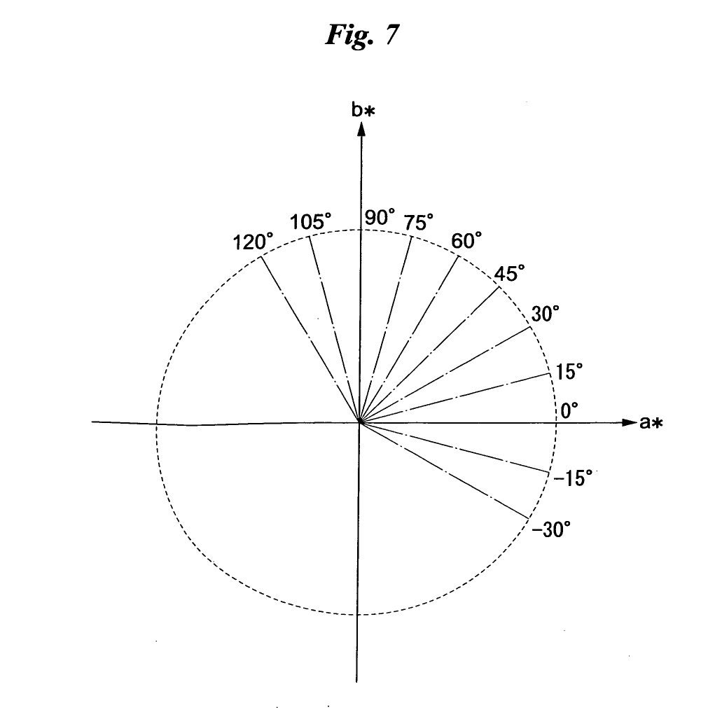

FIG. 6 is a flowchart illustrating processing for deciding gain, etc., for white balance adjustment of CCD-RAW data.

Preprocessing such as extraction of green-component image data from the CCD-RAW data, downsampling and gain elevation is executed (step 31) and this is followed by processing for detecting a face image (step 32).

If a face-image portion is detected from the subject image represented by the extracted image data of the green component (“YES” at step 33), then the position of the detected face-image area is computed (step 34). If a plurality of face-image areas are detected, then, as mentioned above, the position of the largest face-image area may be calculated or the position of another area may be calculated. Of course, it may be so arranged that the positions of all or some of the calculated plurality of face-image areas are calculated. A skin-tone area is detected from within the detected face-image area (step 35). Then, the light source that was used in the environment in which the CCD-RAW data was obtained from the image within the detected skin-tone area, or the color temperature in this environment, is inferred (step 36).

If a face-image portion is not detected from the subject image represented by the extracted image data of the green component (“NO” at step 33), the light source that was used in the environment in which the CCD-RAW data was obtained from the entire subject image, or the color temperature in this environment, is inferred (step 37).

As described above, the white balance gain, linear matrix coefficients and color difference matrix coefficients are decided from the light source or color temperature inferred (step 38). A white balance adjustment, etc., is executed using the decided gain, etc., in the manner described above.

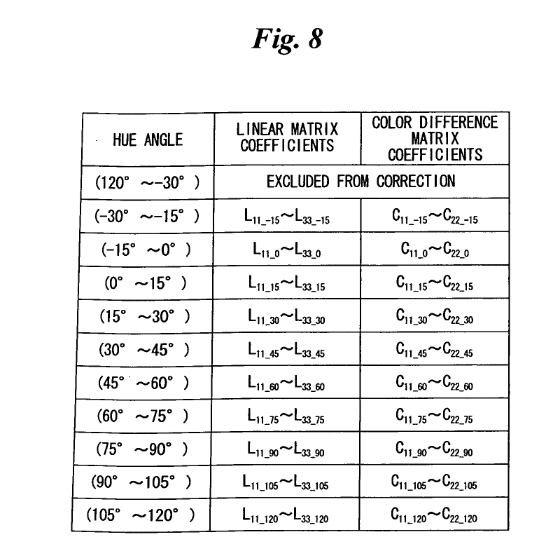

FIGS. 7 to 9 illustrate a second embodiment of the present invention. This embodiment improves the color reproduction of skin tone.

FIG. 7 illustrates hue angle in an a*b* coordinate system in L*a*b* space. The a* axis is adopted as a reference (0°) and hue angle is defined in the counter-clockwise direction. Areas are defined every 15° from hue angles of −30° to 120°. A skin-tone area is detected in a manner similar to that described above and the detected skin tone is plotted in the a*b* coordinate system. The linear matrix coefficients and color difference matrix coefficients are decided in accordance with the hue angle of the plotted skin tone.

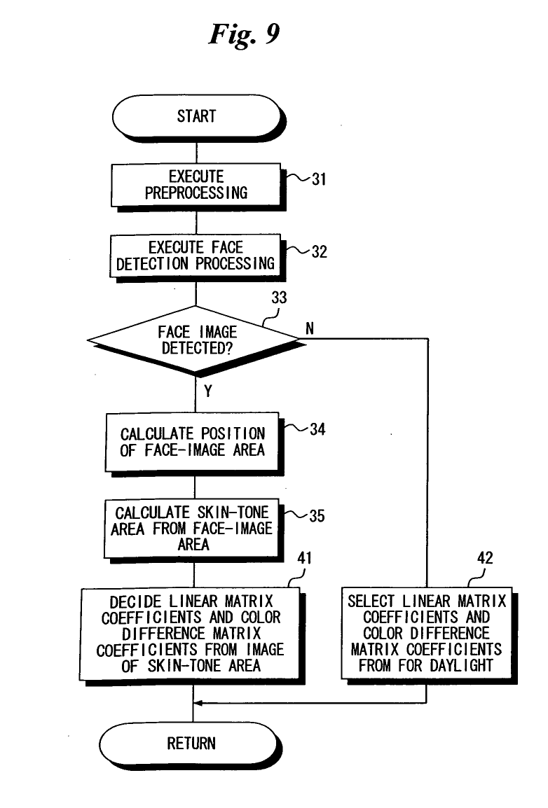

FIG. 8 illustrates an example of a coefficient table.

Linear matrix coefficients and color difference matrix coefficients are defined in accordance with hue angle in the a*b* coordinate system. As described above, hue angles are defined every 15° from hue angles of −30° to 120°, and linear matrix coefficients and color difference matrix coefficients are defined in correspondence with these hue angles. Hue angles of from 120° to −30° do not undergo color correction and neither linear matrix coefficients nor color difference matrix coefficients are defined for these angles. Linear matrix coefficients and color difference matrix coefficients are decided upon in accordance with the hue angle of the detected skin tone, and a color correction is performed in the linear matrix circuit 5 and color difference matrix circuit 9 using the coefficients decided.

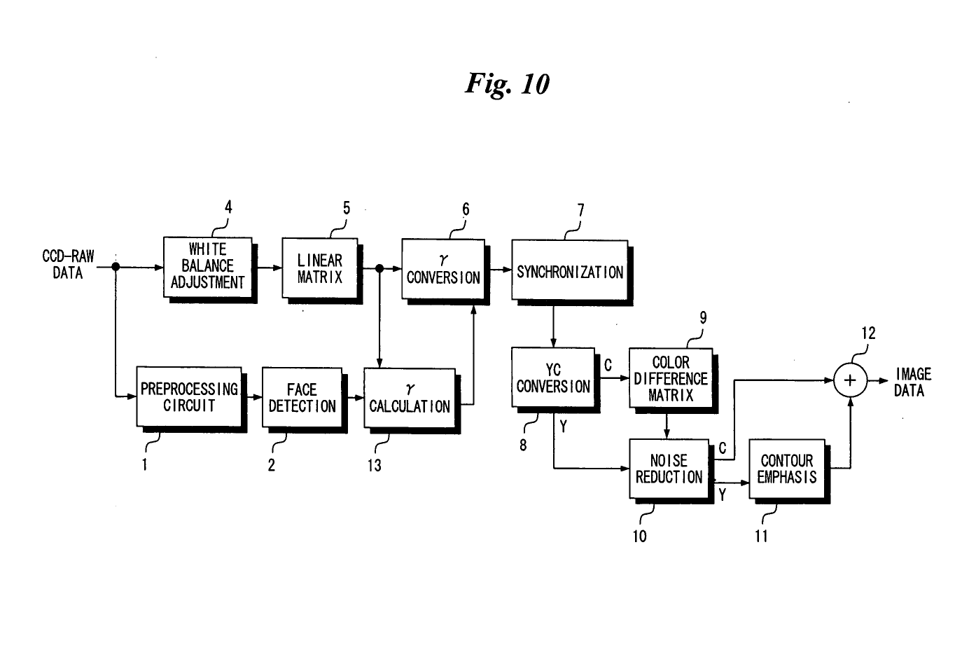

FIG. 9 is a flowchart illustrating processing for deciding linear matrix coefficients and color difference matrix coefficients. Processing in FIG. 9 having steps identical with those shown in FIG. 6 are designated by like step numbers and need not be described again.

If a skin-tone area is detected (step 35), as mentioned above, linear matrix coefficients and color difference matrix coefficients are decided based upon the position of the skin-tone area in the a*b* coordinate system of the color (e.g., the average color) of the image (step 41). A color correction can be performed in the linear matrix circuit 5 and color difference matrix circuit 9 in such a manner that the skin tone takes on the objective color.

If a face image is not detected (“NO” at step 33), standard linear matrix coefficients and color difference matrix coefficients for daylight are selected (step 42). It goes without saying that these linear matrix coefficients and color difference matrix coefficients for daylight are calculated in the parameter calculation circuit 3 and stored beforehand.

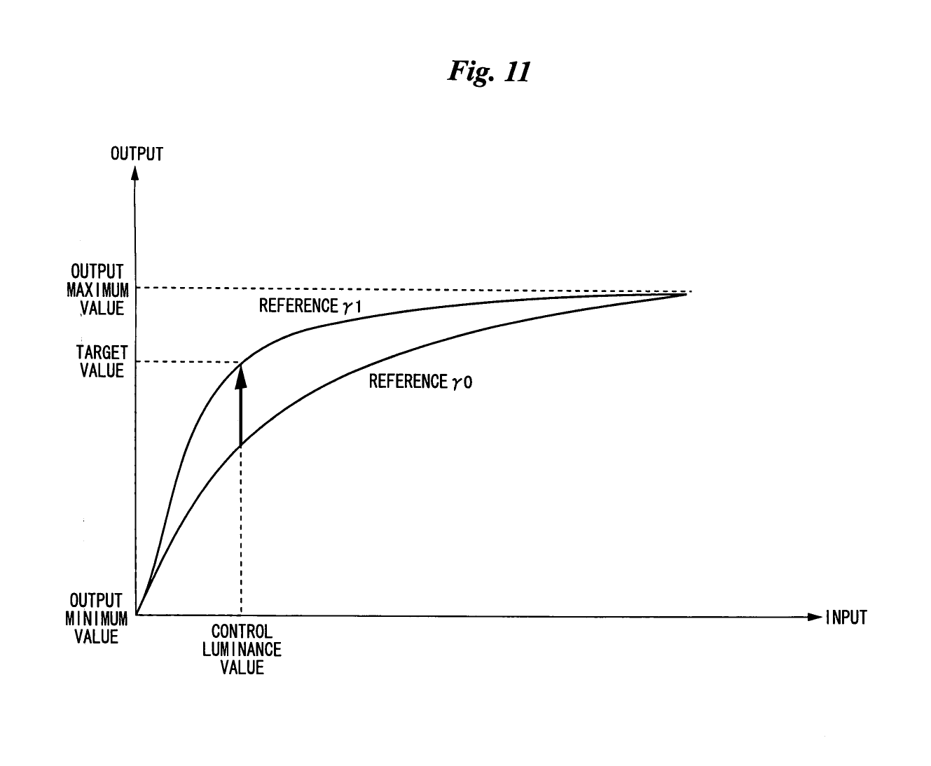

FIGS. 10 to 12 illustrate a third embodiment of the present invention.

In this embodiment, a gamma correction table (gamma correction curve) is created based upon the luminance of a face-image portion and a luminance histogram of the entire image of the subject in such a manner that the face-image portion and overall image of the subject will take on an appropriate brightness. The image data is gamma-corrected using the gamma correction table created.

FIG. 10 is a block diagram illustrating part of the electrical structure of a digital still camera. Components in FIG. 10 identical with those shown in FIG. 1 are designated by like reference characters and need not be described again.

A face image is detected in the face detection circuit 2 and the position of this face image and extracted green-component image data are input to a gamma calculation circuit 13. Also input to the gamma calculation circuit 13 is image data representing the entirety of the subject image color-corrected in the linear matrix circuit 5. The gamma calculation circuit 13 calculates the luminance value of the color-image portion and the luminance value of the overall subject image and creates a revised gamma correction table based upon the luminance values calculated. The revised gamma correction table is applied to the gamma conversion circuit 6, where a gamma conversion is applied to the image data that has been output from the linear matrix circuit 5. This makes it possible to prevent underexposure or overexposure of the face image due to the brightness of the background.

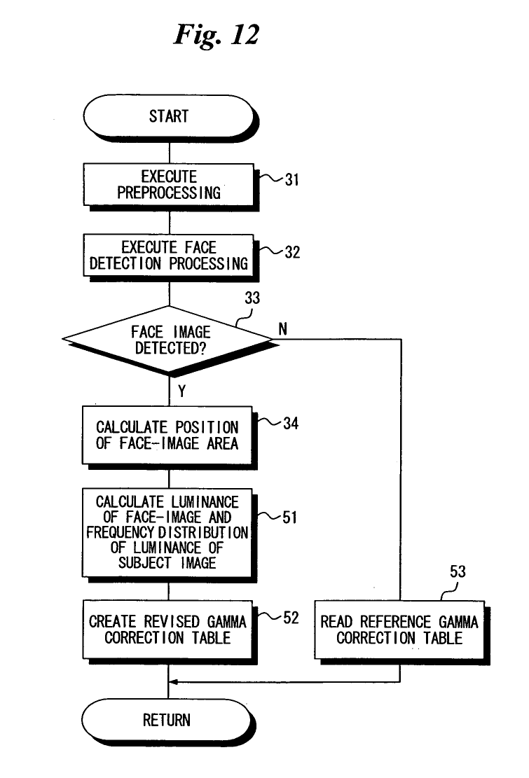

FIG. 11 illustrates an example of a gamma correction curve.

First, a reference gamma correction curve γ0 used in a normal gamma conversion is defined. The luminance value of the detected face image (the value may be the average luminance value of the face image or the luminance of a representative portion of the face image) is adopted as a control luminance value. A target value of the control luminance value is calculated such that the face image and overall subject image take on the appropriate brightness. A revised gamma correction curve γ1 is created by interpolation processing, such as spline interpolation, from the target value, output minimum value and output maximum value. A gamma conversion is performed using the revised gamma correction curve γ1 thus created.

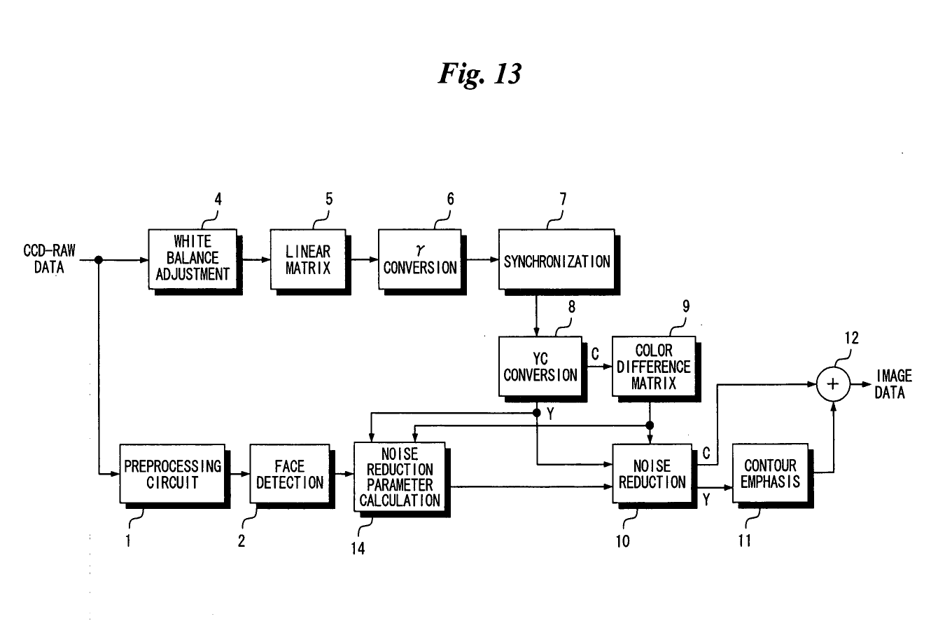

FIG. 12 is a flowchart illustrating processing for creating the gamma correction table (gamma correction curve). Processing in FIG. 12 having steps identical with those shown in FIG. 6 are designated by like step numbers and need not be described again.

If a face-image area is detected (“YES” at step 33), then the luminance of the face image and a frequency distribution of the luminance of the subject image are calculated (step 51). A revised gamma correction table (revised gamma correction curve γ1) is created using the calculated luminance and frequency distribution (step 52). If a face image is not detected (“NO” at step 33), a reference gamma correction table (reference gamma correction table γ0) is read (step 53).

A gamma conversion is performed using the revised gamma correction table or reference gamma correction table created.

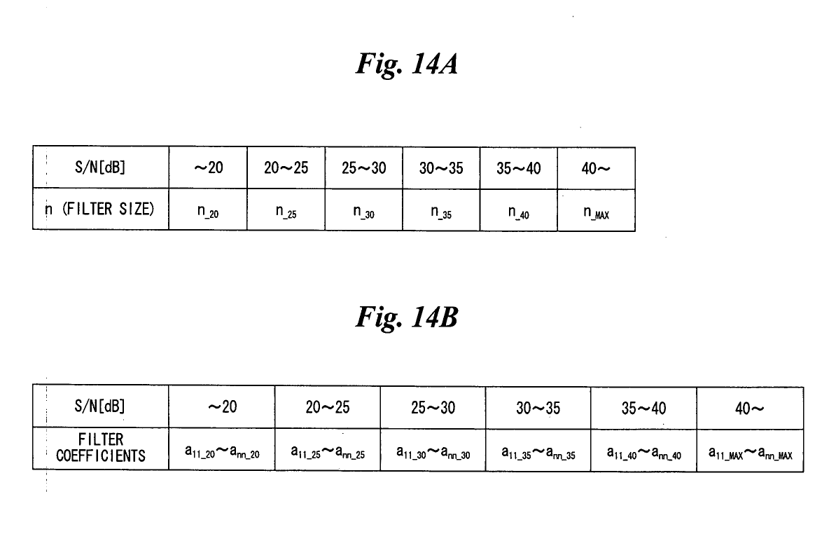

FIGS. 13 to 15 illustrate a fourth embodiment of the present invention.

In this embodiment, noise in a face image is detected and noise reduction parameters in the noise reduction circuit 10 are changed in dependence upon the noise detected.

FIG. 13 is a block diagram illustrating part of the electrical structure of a digital still camera. Components in FIG. 13 identical with those shown in FIG. 1 are designated by like reference characters and need not be described again.

Data representing the detected face-image area and the extracted green-component image data in the face detection circuit 2 is input to a noise reduction parameter calculation circuit 14. The latter calculates the average S/N ratio of the face-image area and, on the basis of the average S/N ratio calculated, calculates parameters that decide filter size (number of taps) and filter coefficients in the noise reduction circuit 10. The parameters calculated are applied from the noise reduction parameter calculation circuit 14 to the noise reduction circuit 10. The latter, which is connected to a latter stage of the YC conversion circuit 8, applies noise reduction processing to the luminance data Y and color difference data C.

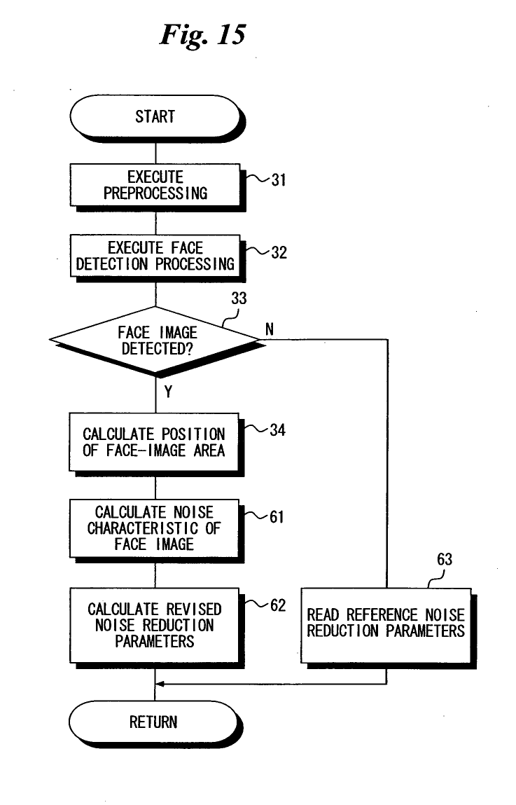

FIGS. 14A and 14B illustrate relationships between S/N ratios of face images and parameters of the noise reduction circuit 10.

Defined in both FIGS. 14A and 14B are S/N ratios of face-image portions of 20 dB or less, 20 to 25 dB, 25 to 30 dB, 30 to 35 dB, 35 to 40 dB and 40 dB or greater, as well as parameters in the noise reduction circuit 10 in conformity with these S/N ratios.

FIG. 14A is a table illustrating the relationship between S/N ratios of face-image portions and filter sizes of the noise reduction circuit 10. S/N ratios of face-image portions of 20 dB or less, 20 to 25 dB, 25 to 30 dB, 30 to 35 dB, 35 to 40 dB and 40 dB or greater have been defined, and filter sizes of the noise reduction circuit 10 have been defined in accordance with these S/N ratios. The noise reduction circuit 10 internally incorporates an n×n filter and executes noise reduction processing using a filter of the filter size stipulated.

FIG. 14B is a table illustrating the relationship between S/N ratios of face-image portions and filter coefficients of the noise reduction circuit 10. S/N ratios of face-image portions of 20 dB or less, 20 to 25 dB, 25 to 30 dB, 30 to 35 dB, 35 to 40 dB and 40 dB or greater have been defined, and filter coefficients of the noise reduction circuit 10 have been defined in accordance with these S/N ratios.

Filter size and filter coefficients are decided in accordance with the S/N ratio of the face-mage portion.

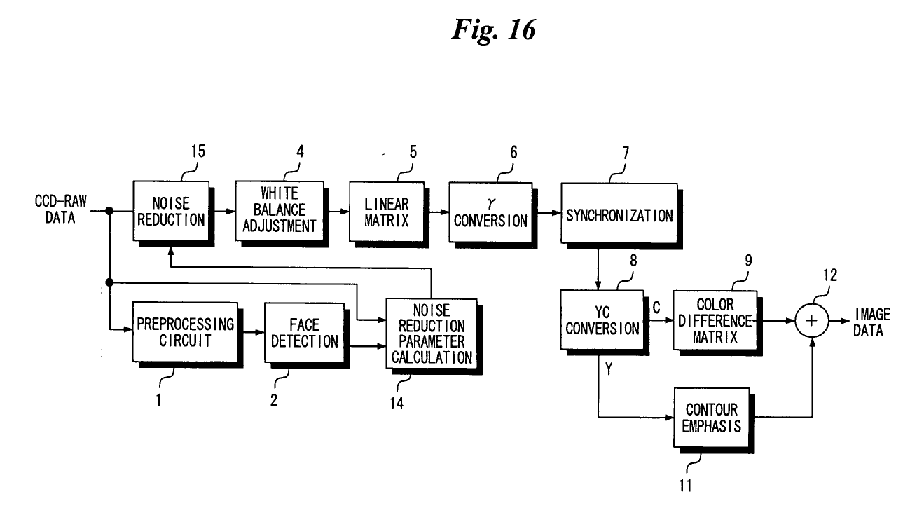

FIG. 15 is a flowchart illustrating processing for calculating noise reduction parameters. Processing in FIG. 15 having steps identical with those shown in FIG. 6 are designated by like step numbers and need not be described again.

If a face image is detected (“YES” at step 33), then the noise characteristic (S/N ratio) of the detected face image is calculated (step 61). Revised noise reduction parameters (filter size, filter coefficients) are calculated (step 62), as described above, based upon the noise characteristic calculated. Noise reduction processing is executed using the revised noise reduction parameters, as a result of which a subject image having a face-image portion with little noise is obtained.

If a face image is not detected (“NO” at step 33), basic noise parameters are read from the noise reduction parameter calculation circuit 14 (step 63).

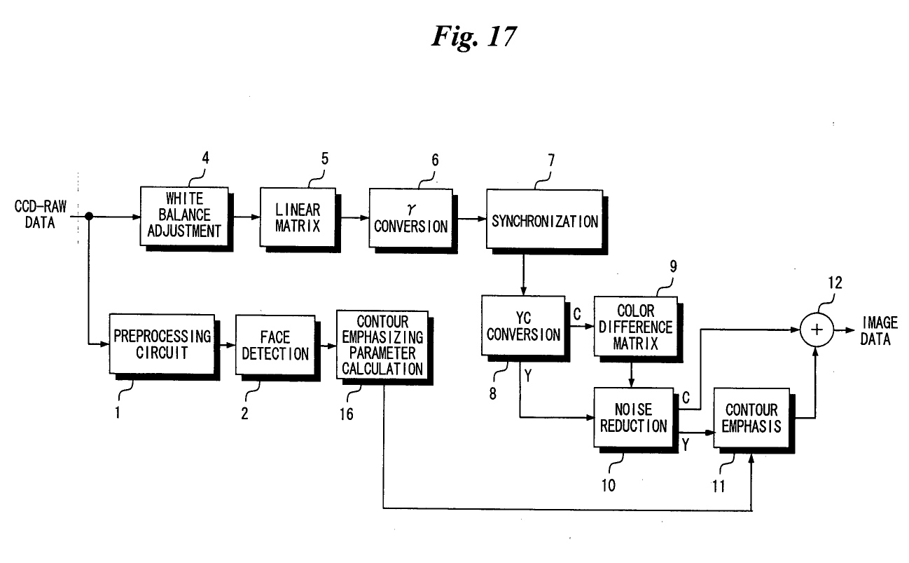

FIG. 16 is a block diagram illustrating the electrical structure of a digital still camera according to a modification. Components in FIG. 16 identical with those shown in FIG. 1 are designated by like reference characters and need not be described again.

In FIG. 13, the noise reduction circuit 10 is connected to a latter stage of the YC conversion circuit 8. In the digital still camera shown in FIG. 16, however, a noise reduction circuit 15 is provided in front of the white balance adjustment circuit 4 in such a manner that the applied CCD-RAW data will enter the noise reduction circuit 15.

Since noise reduction processing is applied to the CCD-RAW data, noise can be prevented from being amplified in subsequent processing.

FIGS. 17 to 19 illustrate a fifth embodiment of the present invention. In this embodiment, the degree of contour emphasis is changed between that in a face-image portion and that in the background.

FIG. 17 is a block diagram illustrating part of the electrical structure of a digital still camera. Components in FIG. 17 identical with those shown in FIG. 1 are designated by like reference characters and need not be described again.

A contour emphasizing parameter calculation circuit 16 is connected to the face detection circuit 2. The contour emphasizing parameter calculation circuit 16 separately calculates contour emphasizing parameters for a face-image portion and contour emphasizing parameters for a background portion. Data representing the position of the face image, contour emphasizing parameters for the face-image portion and contour emphasizing parameters for the background portion are applied from the contour emphasizing parameter calculation circuit 16 to the contour emphasizing circuit 11. The latter applies contour emphasizing processing to the face-image portion and different contour emphasizing processing to the background portion. The face-image portion can be subjected to contour emphasis that is stronger than that applied to the background.

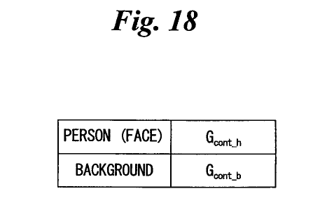

FIG. 18 illustrates an example of a table of contour emphasizing parameters that has been set in the contour emphasizing parameter calculation circuit 16.

Gain G_{conth} applied to the contour components of the face-image portion (the image of a person) and gain G_{contb} applied to the background portion have been set. In the noise reduction circuit 10 the result of applying the gain G_{conth} to the contour components of the face-image portion is added to the luminance data Y, and the result of applying the G_{contb} to the contour components of the background portion is added to the luminance data Y. The face-image portion can be emphasized more that the background.

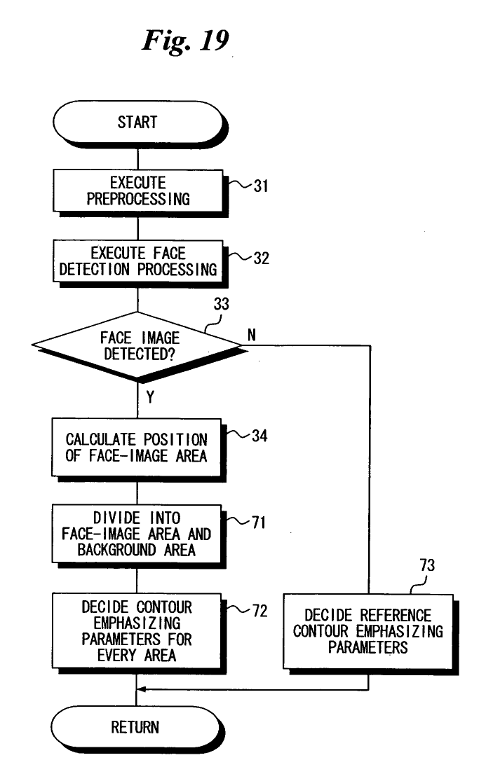

FIG. 19 is a flowchart illustrating processing for deciding contour emphasizing parameters. Processing in FIG. 19 having steps identical with those shown in FIG. 6 are designated by like step numbers and need not be described again.

If a face image is detected (“YES” at step 33), then it is divided into an area of the face-image portion and an area of the background portion (step 71; see FIG. 2). Contour emphasizing parameters are decided for every divided area (step 72). Contour emphasizing processing that differs for every area is executed using the contour emphasizing parameters decided for every area.

If a face image is not detected (“NO” at step 33), reference contour emphasizing parameters according to which contour emphasis is applied to the entirety of the image of the subject are set (step 73). Uniform Contour emphasizing processing is applied to the entirety of the image of the subject using the contour emphasizing parameters that have been set.

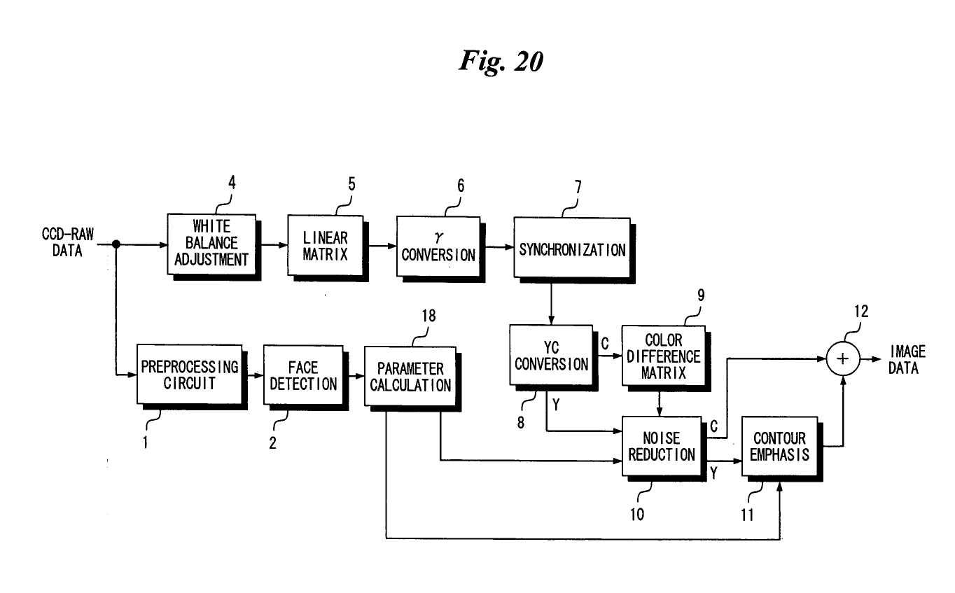

FIGS. 20 to 22 illustrate a sixth embodiment of the present invention. In this embodiment, the degree of noise reduction regarding a face image is changed and so is the degree of contour emphasis.

FIG. 20 is part of a block diagram illustrating the electrical structure of a digital still camera. Components in FIG. 20 identical with those shown in FIG. 1 are designated by like reference characters and need not be described again.

A parameter calculation circuit 18 calculates the S/N ratio of a face-image portion and, in a manner similar to that described above, decides filter size and filter coefficients, which conform to the S/N ratio, in the noise reduction circuit 10 (see FIG. 14). The parameter calculation circuit 18 further decides the gain (contour gain), which is used in contour emphasizing processing, in accordance with the S/N ratio.

Data representing the filter size and filter coefficients is applied from the parameter calculation circuit 18 to the noise reduction circuit 10 in accordance with the S/N ratio of the face-image portion, and data representing the contour gain that conforms to the S/N ratio of the face-image portion is applied from the parameter calculation circuit 18 to the contour emphasizing circuit 11. Noise reduction processing conforming to the noise in the face-image portion is executed, and the image blurred by the noise reduction has its contour emphasized in accordance with noise reduction.

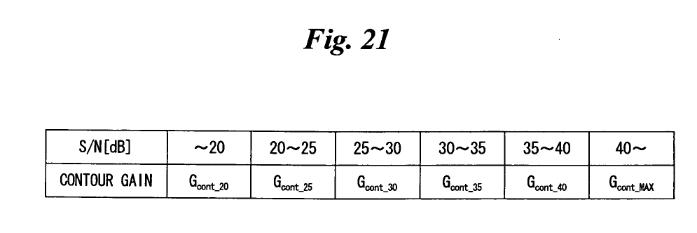

FIG. 21 illustrates an example of a table indicating the relationship between S/N ratios of face-image portions and contour gains.

S/N ratios of face-image portions of 20 dB or less, 20 to 25 dB, 25 to 30 dB, 30 to 35 dB, 35 to 40 dB and 40 dB or greater have been defined, and contour gains have been defined in accordance with these S/N ratios. It will be understood that by applying contour gain corresponding to the S/N ratio to the noise reduction circuit 10, contour emphasizing processing conforming to the S/N ratio is executed.

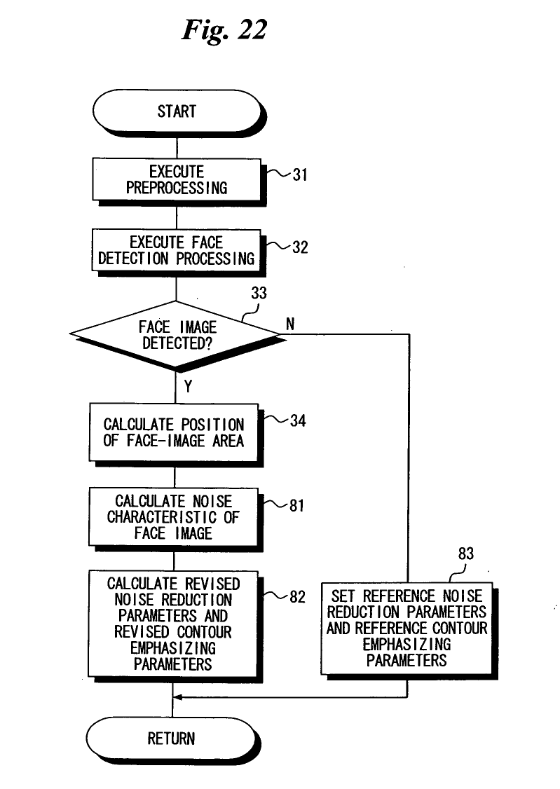

FIG. 22 is a flowchart illustrating processing for calculating revised noise reduction parameters and revised contour emphasizing parameters. Processing in FIG. 22 having steps identical with those shown in FIG. 6 are designated by like step numbers and need not be described again.

If a face image is detected (“YES” at step 33), then the noise characteristic (S/N ratio) of the face image is calculated (step 81). Revised noise reduction parameters (filter size, filter coefficients) and revised contour emphasizing parameters (contour gain) are calculated in accordance with the noise characteristic calculated (step 82). Noise reduction processing is executed using the revised noise reduction parameters calculated, and contour emphasizing processing is executed using the revised contour emphasizing parameters calculated, whereby there is obtained a subject image having a face-image portion with a sharp contour and less noise as well.

If a face image is not detected (“NO” at step 33), then predetermined reference noise reduction parameters and reference contour emphasizing parameters are set (step 83). Noise reduction processing is executed using the reference noise reduction parameters and contour emphasizing processing is executed using the reference contour emphasizing parameters.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for correcting color of subject-image data, comprising:
a target-image detecting device for detecting a target image from a subject image represented by subject-image data applied thereto;
a color correction parameter deciding device for deciding color correction parameters based upon the target image detected by said target-image detecting device; and
a color correction circuit for applying a color correction to the subject-image data in accordance with the color correction parameters decided by said color correction parameter deciding device.

2. The apparatus according to claim 1, wherein said target-image detecting device detects a skin-tone image portion from the subject image.

3. The apparatus according to claim 1, wherein said color correction parameter deciding device includes a light-source/color-temperature detecting device for detecting, based upon the target image detected by said target-image detecting device, at least one of the kind of light source under which the subject image was obtained and color temperature in the environment in which the image of the subject was sensed; and
said color correction parameter deciding device deciding the color correction parameters based upon at least one of the light source and color temperature detected by said light-source/color-temperature detecting device.

4. An apparatus for applying a gamma correction to subject-image data, comprising:
a target-image detecting device for detecting a target image from a subject image represented by subject-image data applied thereto;
a gamma correction coefficient deciding device for deciding gamma correction coefficients based upon the target image detected by said target-image detecting device; and
a gamma correction circuit for applying a gamma correction to the subject-image data in accordance with the gamma correction coefficients decided by said gamma correction coefficient deciding device.

5. An apparatus for reducing noise in subject-image data, comprising:
a target-image detecting device for detecting a target image from a subject image represented by subject-image data applied thereto;
a noise reduction parameter deciding device for deciding noise reduction parameters based upon the target image detected by said target-image detecting device; and
a noise reduction circuit for applying noise reduction processing to the subject-image data in accordance with the noise reduction parameters decided by said noise reduction parameter deciding device.

6. The apparatus according to claim 5, wherein the applied subject-image data is color image data in which a plurality of color elements are output in order;
said apparatus further comprising a synchronizing circuit for executing synchronizing processing to interpolate the color image data by the color elements, thereby obtaining color image data on a per-color-element basis;
said noise reduction circuit applying noise reduction processing to color image data that has been output from said synchronizing circuit.

7. The apparatus according to claim 5, wherein the subject-image data that is input to said noise reduction circuit is CCD-RAW data.

8. The apparatus according to claim 5, further comprising a contour emphasizing circuit for deciding contour emphasizing parameters in accordance with the noise reduction parameters decided by said noise reduction parameter deciding device, and subjecting subject-image data, which has undergone noise reduction processing in said noise reduction circuit, to contour emphasizing processing using the contour emphasizing parameters decided.

9. The apparatus according to claim 5, further comprising a noise-amount detecting device for detecting amount of noise in a target image detected by said target-image detecting device;
wherein said noise reduction parameter deciding device decides the noise reduction parameters based upon the amount of noise detected by said noise-amount detecting device.

10. An apparatus for contour emphasis of subject-image data, comprising:
a target-image detecting device for detecting a target image from a subject image represented by subject-image data applied thereto;
a contour emphasizing parameter deciding device for deciding first contour emphasizing parameters of the target image detected by said target-image detecting device and second contour emphasizing parameters of an image portion of the subject image from which the target image is excluded; and
a contour emphasizing circuit for applying contour emphasizing processing to image data representing the target image in the subject-image data using the first contour emphasizing parameters, and applying contour emphasizing processing to image data representing the image portion from which the target image is excluded using the second contour emphasizing parameters.

11. A method of controlling an apparatus for correcting color of subject-image data, comprising the steps of:
detecting a target image from a subject image represented by applied subject-image data;
deciding color correction parameters based upon the target image detected; and
applying a color correction to the subject-image data in accordance with the color correction parameters decided.

12. A method of controlling an apparatus for applying a gamma correction to subject-image data, comprising the steps of:
detecting a target image from a subject image represented by applied subject-image data;
deciding gamma correction coefficients based upon the target image detected; and
applying a gamma correction to the subject-image data in accordance with the gamma correction coefficients decided.

13. A method of controlling an apparatus for reducing noise in subject-image data, comprising the steps of:
detecting a target image from a subject image represented by applied subject-image data;
deciding noise reduction parameters based upon the target image detected; and
applying noise reduction processing to the subject-image data in accordance with the noise reduction parameters decided.

14. A method of controlling an apparatus for contour emphasis of subject-image data, comprising the steps of:
detecting a target image from a subject image represented by applied subject-image data;
deciding first contour emphasizing parameters of the detected target image and second contour emphasizing parameters of an image portion of the subject image from which the target image is excluded; and
applying contour emphasizing processing to image data representing the target image in the subject-image data using the first contour emphasizing parameters, and applying contour emphasizing processing to image data representing the image portion from which the target image is excluded using the second contour emphasizing parameters.
